(19) United States
(12) Patent Application Publication
(10) Pub. No.: US 2006/0007262 A1
(43) Pub. Date: Jan. 12, 2006

(54) CAPPING DEVICE FOR CAPPING A PRINT HEAD

(76) Inventor: Shr-How Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/908,704

(22) Filed: May 23, 2005

(30) Foreign Application Priority Data
Jul. 7, 2004 (TW) 093120322

(51) Int. Cl. B41J 2/165

(52) U.S. Cl. 347/29

(57) ABSTRACT

A capping device for capping a print head of a printer includes a cap for capping the print head, a supporting structure for mechanically engaging and disengaging the cap with the print head, and an elastic structure installed inside the cap. The top of the cap is lower than the top of the elastic structure. Before the supporting structure engages the cap with the print head, the top of the elastic structure bends outward and contacts the print head in an incomplete sealed manner.

### BACKGROUND OF INVENTION

1. Field of the Invention

The present invention relates to a capping device and more particularly, to a capping device capable of preventing a sudden capping pressure generated during the capping process from destroying the surface tension of ink.

2. Description of the Prior Art

Ink jet print systems are used for fax machines, printers, photocopiers, or other office appliances. The ink jet print system includes a capping device for capping a print head so as to ensure normal operation of the print head. When the inkjet print system is not used, the capping device is capable of capping the print head to prevent the ink in the nozzles from drying so as to jam the print head.

Please refer to FIG. 1 and FIG. 2. FIG. 1 is a schematic drawing of a conventional capping device 10, and FIG. 2 is a schematic drawing of a cap 12 of the capping device 10. The capping device 10 includes the cap 12, a cap sled 14, and a cap housing 16. The cap sled 14 is capable of carrying the cap 12, and the cap housing 16 is installed on a print track (not shown in FIG. 1) in a slidable manner for carrying the cap sled 14. When a carrier of an ink cartridge (not shown in FIG. 1) moves to the capping device 10, the cap sled 14 can be driven upward for driving the cap 12 upward to cap a print head of the ink cartridge. When the cap 12 caps the print head, the air system outside the print head and covered by the cap 12 will be transformed from an open system to a closed system. This results in air volume compression so as to generate a sudden increase in pressure. The sum of the sudden pressure and a back pressure of the ink cartridge must be less than surface tension of the ink so that the pressure does not destroy the surface tension of the ink. However in the prior art, the common method for preventing the capping device from generating the excess sudden pressure is by forming a hole on the surface of the cap 12 so as to promote circulation between the air inside and outside of the cap 12 because this prevents the volume of the air from decreasing suddenly and the sudden pressure will not be generated. Unfortunately, the design mentioned above has a disadvantage of drying the nozzle.

Furthermore, the movement of the carrier of the ink cartridge might deform the outer sides of the cap 12 so that a gap between the cap 12 and the print head will be generated, and the nozzle will dry due to unsealed combination of the cap 12 and the print head.

### SUMMARY OF INVENTION

It is therefore a primary objective of the claimed invention to provide a capping device capable of preventing a sudden capping pressure generated during the capping process from destroying the surface tension of ink for solving the above-mentioned problem.

According to the claimed invention, a capping device for capping a print head of a printer includes a cap for capping the print head, a supporting structure for mechanically engaging and disengaging the cap with the print head, and an elastic structure installed inside the cap. The top of the cap is lower than the top of the elastic structure. Before the supporting structure engages the cap with the print head, the top of the elastic structure bends outward and contacts the print head in an incomplete sealed manner.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic drawing of a conventional capping device.

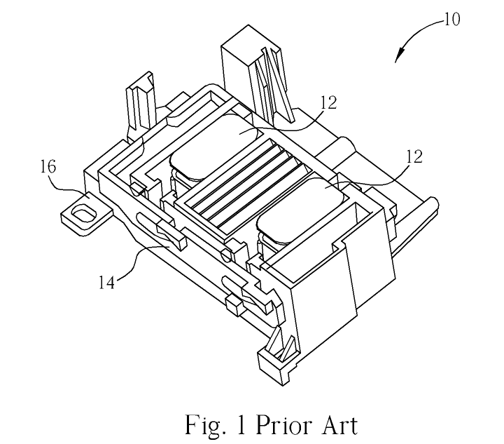

FIG. 2 is a schematic drawing of a cap of the capping device shown in FIG. 1.

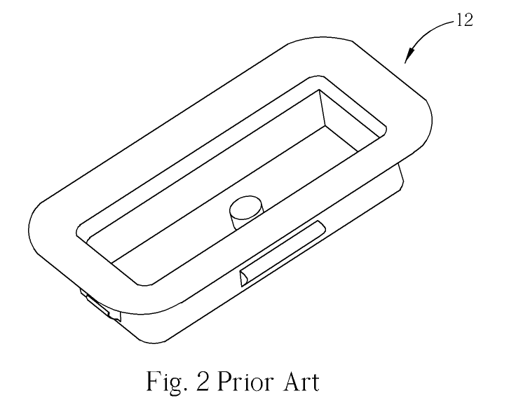

FIG. 3 is a perspective drawing of a printer of the present invention.

FIG. 4 is a schematic drawing of a capping device shown in FIG. 3 of the present invention.

FIG. 5 is a schematic drawing of a cap shown in FIG. 3 of the present invention.

FIG. 6 is a lateral view of the cap.

FIG. 7 is a diagram illustrating that an elastic structure shown in FIG. 5 contacts with an ink cartridge shown in FIG. 3 and deforms during the capping process.

FIG. 8 is a diagram that illustrates the cap contacting the ink cartridge.

### DETAILED DESCRIPTION

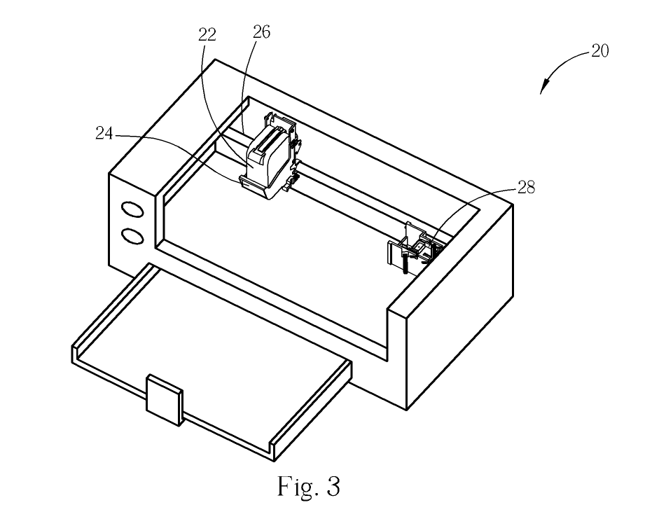

Please refer to FIG. 3. FIG. 3 is a perspective drawing of a printer 20 of the present invention. The printer 20 includes an ink cartridge 22 installed on a carrier 24. The ink cartridge 22 contains ink for printing. The carrier 24 can carry the ink cartridge 22 to move on a print track 26, and a print head (not shown in FIG. 3) on the bottom of the ink cartridge 22 can print images on a print medium (not shown in FIG. 3). The print head includes at least one nozzle (not shown in FIG. 3) to jet out ink onto the print medium. The printer 20 further includes a capping device 28 installed on one side of the print track 26. When the ink cartridge 22 finishes printing, the carrier 24 can drive the ink cartridge 22 to the capping device 28 for capping the print head.

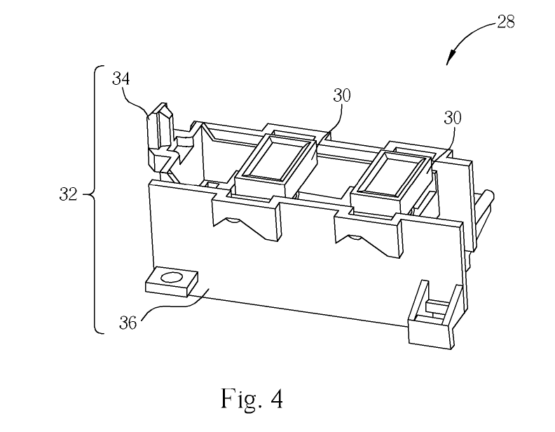

Please refer to FIG. 4. FIG. 4 is a schematic drawing of the capping device 28 of the present invention. The capping device 28 includes two caps 30, and a supporting structure 32. The supporting structure 32 includes a cap sled 34, and a cap housing 36. The cap sled 34 is capable of carrying the cap 30, and the cap housing 36 is installed on the print track 26 in a slidable manner for carrying the cap sled 34. The left and right movement of the carrier 24 can be transformed into upward and downward movement. When the carrier 24 of the ink cartridge 24 moves to the capping device 28, the cap sled 34 will be driven upward so as to drive the cap 30 to cap the print head of the ink cartridge 22.

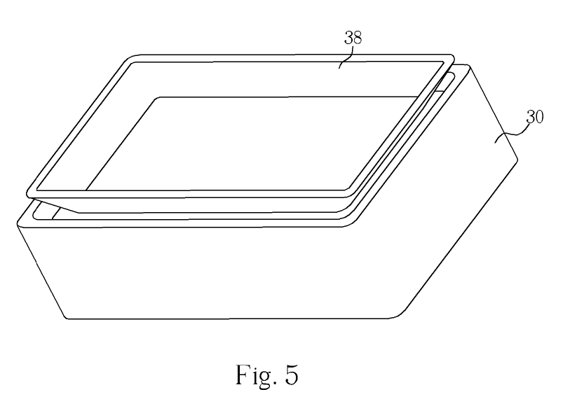

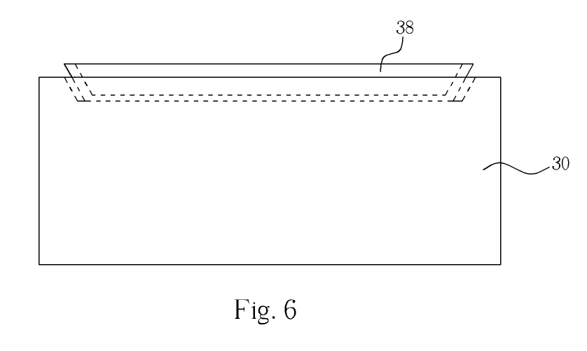

Please refer to FIG. 5 and FIG. 6. FIG. 5 is a schematic drawing of the cap 30 of the present invention. FIG. 6 is a lateral view of the cap 30. The capping device 28 further includes an elastic structure 38 installed inside the cap 30. A room is formed inside one side of the cap 30, and the elastic structure 38 is positioned inside the room. The top of the cap 30 is lower than the top of the elastic structure 38. The elastic structure 38 includes four inclined planes extending outwardly to the outer sides of the cap 30, and the elastic structure 38 is a petal structure. The elastic structure 38 can be connected to the cap 30 to create a monolithic structure.

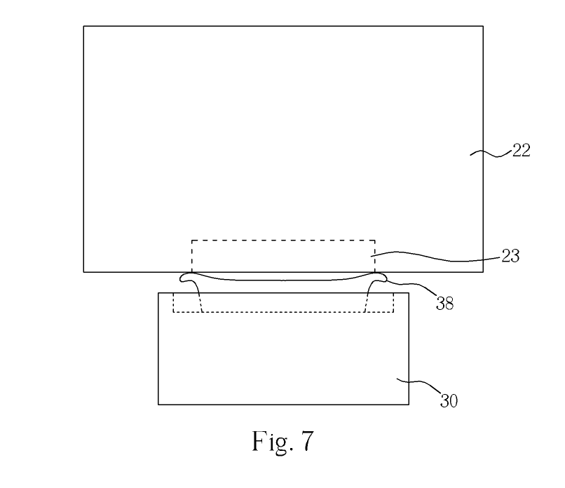

When the carrier 24 of the ink cartridge 22 moves to the capping device 28, the cap sled 34 can be driven upward. Because the elastic structure 38 is higher than the cap 30, during the capping process the elastic structure 38 can contact the ink cartridge 22 first. And during the contact process of the elastic structure 38 and the ink cartridge 22, the inclined planes of the elastic structure 38 will be deformed by the compression of the print head. Please refer to FIG. 7. FIG. 7 is a diagram illustrating that the elastic structure 38 contacts with the ink cartridge 22 and deforms during the capping process. The elastic structure 38 is compressed and the top of the elastic structure 38 will bend outward so that the elastic structure 38 cannot be combined with the print head 23 of the ink cartridge 22 tightly and a gap between the elastic structure 38 and the print head 23 of the ink cartridge exists. That is, the elastic structure 38 caps the print head in an unsealed manner. At this time the difference between the ambient pressure and the pressure of the air covered by the elastic structure 38 is small because the elastic structure 38 can not cap the print head tightly. The pressure outside and inside the elastic structure 38 will balance, and it will not cause the great sudden capping pressure. If the sum of the sudden capping pressure and the back pressure of the ink cartridge is greater than the surface tension of the ink, the air will flow into the nozzle so that there are bubbles in the nozzle and the print quality will decrease.

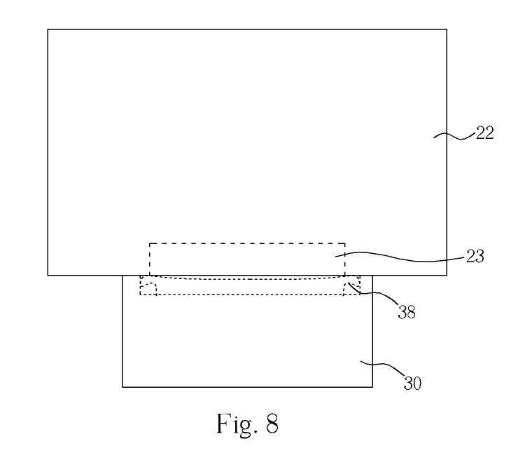

Please refer to FIG. 8. FIG. 8 is a diagram that illustrates the cap 30 contacting the ink cartridge 22. When the capping device 28 rises to a predetermined position, the elastic structure 38 is compressed by the print head 23 to extend outward. At the same time, the cap 30 having a trapezoid shape outside the elastic structure 38 contacts the ink cartridge 22 afterward to provide the second protection layer. Because the cap 30 is composed of four planes perpendicularly to the print head 23 instead of four inclined planes extending outwardly of the elastic structure 38, the cap will not bend out when contacting the ink cartridge 22 so that the print head 23 can be properly sealed.

The purpose of the present invention is to pre-cap the print head 23. That is, during the capping process the elastic structure 38 contacts the ink cartridge 22 first and then caps the print head 23 in an incomplete sealed manner, so the difference between the ambient pressure and the pressure of the air covered by the elastic structure 38 is small so as to prevent the sudden capping pressure from destroying the surface tension of the ink. Finally the capping device 28 rises to the predetermined position, and the cap 30 can cap the print head 23 completely to prevent the print head 23 from drying.

In the present invention the cap 30 and the elastic structure 38 can be made of rubber material. Because rubber is elastic, it is easy to create these parts from a mold and to mass produce these parts.

Compared to the conventional capping device, the capping device of the present invention not only can avoid the problem of a sudden capping pressure generated during the capping process destroying the surface tension of the ink but also can seal the print head tightly to prevent the print head from drying. Furthermore, the present invention merely modifies the structure of the capping device instead of applying additional devices for capping, and the manufacture is very easy. Therefore the present invention provides a low cost and effective solution to solve the problems of the conventional capping mechanism.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A capping apparatus for capping a print head of a printer comprising:
a cap for capping the print head;
a supporting structure for mechanically engaging and disengaging the cap with the print head; and
an elastic structure installed inside the cap, the top of the cap being lower than the top of the elastic structure, wherein the top of the elastic structure bends outward and contacts the print head in an incomplete sealed manner before the supporting structure engages the cap with the print head.

2. The capping apparatus of claim 1 wherein the elastic structure comprises four inclined planes extending outwardly to the outer sides of the cap.

3. The capping apparatus of claim 2 wherein when the elastic structure contacts with the print head, the inclined planes deform with the compression of the print head.

4. The capping apparatus of claim 1 wherein the elastic structure is a petal structure.

5. The capping apparatus of claim 1 wherein a room is formed inside the cap and the elastic structure is positioned inside the room.

6. The capping apparatus of claim 5 wherein the elastic structure is connected to the cap to create a monolithic structure.

7. The capping apparatus of claim 1 wherein the elastic structure and the cap are made of rubber.

8. The capping apparatus of claim 1 wherein the supporting structure comprises:
a cap sled for carrying the cap and the elastic structure; and
a cap housing installed on a print track in a slidable manner for carrying the cap sled.
